(19) United States
(12) Patent Application Publication
(10) Pub. No.: US 2010/0116829 A1
(43) Pub. Date: May 13, 2010

(54) POLYISOCYANURATE RIGID FOAMS AND PROCESSES FOR THEIR PRODUCTION AND USE

(75) Inventors: Allard Van Der Wal, EK Nijholtpade (NL); Marcel B. Haak, AV Loppersum (NL)

Correspondence Address: BAYER MATERIAL SCIENCE LLC, 100 BAYER ROAD, PITTSBURGH, PA, 15205, US

(73) Assignee: Bayer MaterialScience AG, Leverkusen (DE)

(21) Appl. No.: 12/612,102

(22) Filed: Nov. 4, 2009

(30) Foreign Application Priority Data
Nov. 7, 2008 (EP) 08019496.2/EP0801

(51) Int. Cl. B65D 90/04; C08G 18/00; C08G 18/28; B32B 1/02

(52) U.S. Cl. 220/565; 521/157; 521/117; 428/36.5

(57) ABSTRACT

PIR rigid foams are produced from a polyisocyanate component and a polyol component that includes at least one polyester polyol and at least one polyether polyol. The polyisocyanate and polyol components are reacted in amounts such that the volume ratio of polyisocyanate component to polyol component is from 100:100 to 100:110 and the index is from 100 to 400. These foams are characterized by good adhesion to a substrate and impermeability to water vapor. The foams are generally produced by a casting process and are particularly useful as an insulating material for containers and tanks.

### BACKGROUND OF THE INVENTION

The present invention relates to polyisocyanurate (PIR) rigid foams and to processes for the production and use of these PIR rigid foams.

EP-A 1219653 discloses PIR rigid foams based on aromatic polyester polyols with improved flame resistance and low thermal conductivity. In addition, the use of aliphatic, cycloaliphatic or heterocyclic polyester polyols is also proposed.

U.S. Pat. No. 6,495,722 describes the use of polyols based on a Mannich base for the production of purely water-blown systems, since good flame resistance and dimensional stability can be made possible only by the use of polyols of this type. A great disadvantage of these polyols based on a Mannich base is their high viscosity and associated processability issues when used in a spray foam system. Because of the high viscosity, mixing faults readily occur and thus foams with poor physico-mechanical properties are formed.

The known PIR rigid foams have poor flow characteristics, are extremely brittle and/or exhibit low adhesion to the substrate.

At present, only PIR slabstock foams are used for beer tank insulation. These slabstock foams are not completely impermeable to water vapor, therefore condensation problems often occur.

### SUMMARY OF THE INVENTION

The object of the present invention was to provide PIR rigid foams which are not brittle and have good flow characteristics, so that they can be used in a pouring process. These foams should also adhere well to the substrate to which they are applied and should be impermeable to water vapor so that no condensation problems occur.

It has now been found that, when a particular combination of polyols, catalysts and blowing agents is used in the right mixing ratio, PIR rigid foams with low thermal conductivity, reduced brittleness, with very good dimensional stability and improved surface adhesion and surface quality can be produced. These foams can be employed in a pouring process in situ.

### DETAILED DESCRIPTION OF THE INVENTION

The present invention is directed to PIR rigid foam-forming systems which include an organic polyisocyanate component and a polyol component containing hydrogen atoms that are reactive towards isocyanate groups and to the foams produced with these systems. The index (i.e., the molar ratio of the isocyanate groups to the hydrogen atoms that are reactive towards isocyanate groups multiplied by 100) is from 100 to 400, most preferably from 185 to 250. Suitable auxiliary substances and additives, blowing agents and water as well as catalysts may also be included. The polyol component contains at least one polyester polyol and at least one polyether polyol. The volume ratio of the polyol component to the organic polyisocyanate component is from 100:100 to 100:110.

The organic polyisocyanates suitable for use in the polyisocyanate component for the production of PIR rigid foams in accordance with the present invention include mixtures of isomers of diphenylmethane diisocyanate (MDI) and its oligomers. These mixtures are generally referred to as “polymeric MDI” (pMDI). The NCO content is preferably from 28 to 32 wt. %. NCO prepolymers may also be used as the organic polyisocyanate component. Suitable NCO prepolymers include those produced by reaction of polymeric MDI with aliphatic or aromatic polyether polyols or polyester polyols (e.g. polyether polyols or polyester polyols having 1 to 4 hydroxyl groups with a number average molecular weight of 60 to 4000).

The mixture of polyol component, blowing agents, catalysts, flame retardants, stabilizers and other auxiliary substances and additives used to produce the PIR foams of the present invention is referred to below as “component A”.

The polyol component of the PIR rigid foam-forming systems of the present invention contains at least at least one polyester polyol and at least one polyether polyol. In addition, one or more Mannich base polyols may also be used in the polyol component.

Mannich base polyols suitable for use in the PIR rigid foam-forming systems of the present invention can preferably be produced from bisphenol A, phenol or nonylphenol as initiator as well as formaldehyde and diethanolamine with subsequent propoxylation and/or ethoxylation. They preferably have OH numbers of between 350 and 700 mg KOH/g and functionalities of from 2.5 to 5. They are preferably included in a quantity of 0 to 20 wt. %, based on the total weight of component A.

The polyester polyol included in the polyol component of the present invention is preferably an aromatic polyester polyol, preferably based on phthalic acid or phthalic anhydride with e.g. diethylene glycol, recycled polyethylene terephthalate or recycled dimethyl terephthalate (e.g., transesterified with diethylene glycol). The polyester polyol preferably has an OH number of from 150 to 350 and a functionality of from 2 to 2.5 and is preferably present in a quantity of from 15 to 35 wt. %, based on the total weight of component A. More than one polyester polyol satisfying these criteria may, of course, be included in the polyol component of the present invention.

The polyether polyol included in the polyol component of the present invention is preferably based on propylene oxide and/or ethylene oxide with sorbitol or sucrose and optionally another diol or polyol (e.g., glycerol, monopropylene glycol or H₂O) as initiator. The polyether polyol preferably has an OH number of from 400 to 600 and a functionality of from 3.5 to 6 and is preferably used in a quantity of from 5 to 30 wt. %, based on the total weight of component A. More than one polyether polyol satisfying these criteria may, of course, be included in the polyol component of the present invention.

A particularly preferred polyol component includes (1) a polyester polyol having an OH number of from 220 to 260 mg KOH/g, a viscosity of 1500 to 2500 mPas at 25° C. and a functionality of from 2 to 2.5 based on polyethylene terephthalate and (2) a polyether polyol having an OH number of from 450 to 500 mg KOH/g, and a functionality of 5 to 6 which is based on propylene oxide with sorbitol and 1,2-propylene glycol as initiators.

Flame retardants are generally added to the polyol component, most preferably in a quantity of from 5 to 35 wt. %, based on total weight of component A. Suitable flame retardants are known to those skilled in the art and are described, for example, in “Kunststoffhandbuch”, Volume 7, “Polyurethane”, chapter 6.1. Example of suitable flame retardants include brominated and chlorinated paraffins or phosphorus compounds, such as the esters of orthophosphoric acid and metaphosphoric acid, which may also contain halogen. Specific examples of suitable flame retardants are: triethyl phosphate, diethylethane phosphonate, cresyl diphenyl phosphate, dimethylpropane phosphonate and tris(β-chloroisopropyl) phosphate. Flame retardants that are liquid at room temperature are preferred.

The amount of blowing agent and water co-blowing agent used is that which is needed to produce a dimensionally stable foam matrix having the desired density. This is generally between 0.2 and 1.5 wt. % of water co-blowing agent and between 0.5 and 20 wt. % of blowing agent, based in each case on the total weight of component A.

Hydrocarbons are preferably used as the blowing agent. Examples of suitable blowing agents include the isomers of pentane and fluorinated hydrocarbons such as HFC 245fa (1,1,1,3,3-pentafluoropropane), HFC 365mfc (1,1,1,3,3-pentafluorobutane), HFC 134a and mixtures thereof. It is also possible to combine different classes of blowing agents. For example, use of mixtures of n- or i-pentane with HFC 245fa in a ratio of 75:25 (n-/i-pentane:HFC 245fa), makes it possible to produces foams having thermal conductivities of less than 20 mW/mK, measured at 10° C.

Any of the catalysts conventionally used in polyurethane chemistry may be added to the polyol component of the present invention. The amine catalyst(s) used to produce a PIR rigid foam (preferably in quantities of from 0.05 to 3 wt. %, based on total weight of component A) and the salt(s) used as trimerisation catalyst (preferably in quantities of from 0.1 to 5 wt. %, based on total weight of component A) are used in amounts such that the PIR foam is suitable for the intended use (e.g., for insulations on pipes, walls, roofs and tanks (e.g. beer tanks)) and has a sufficient cure time.

Examples of suitable catalysts include: triethylenediamine, N,N-dimethylcyclohexylamine, tetramethylenediamine, 1-methyl-4-dimethylaminoethylpiperazine, triethylamine, tributylamine, dimethylbenzylamine, N,N′N″-tris-(dimethylaminopropyl)hexahydrotriazine, dimethylaminopropylformamide, N,N,N′,N′-tetramethylethylenediamine, N,N,N′,N′-tetramethylbutanediamine, tetramethylhexanediamine, pentamethyldiethylenetriamine, tetramethyldiaminoethyl ether, dimethylpiperazine, 1,2-dimethylimidazole, 1-azabicyclo[3.3.0]octane, bis(dimethylaminopropyl) urea, N-methylmorpholine, N-ethylmorpholine, N-cyclohexylmorpholine, 2,3-dimethyl-3,4,5,6-tetrahydropyrimidine, triethanolamine, diethanolamine, triisopropanolamine, N-methyldiethanolamine, N-ethyldiethanolamine, dimethylethanolamine, tin(II) acetate, tin(II) octoate, tin(II) ethylhexoate, tin(II) laurate, dibutyltin diacetate, dibutyltin dilaurate, dibutyltin maleate, dioctyltin diacetate, tris(N,N-dimethylaminopropyl-s-hexahydrotriazine, tetramethylammonium hydroxide, sodium acetate, sodium octoate, potassium acetate, potassium octoate, sodium hydroxide and mixtures of these catalysts.

Foam stabilisers may also be added to the polyol component of the present invention. Polyether siloxanes are preferred. These compounds are generally a copolymer of ethylene oxide and propylene oxide linked to a polydimethylsiloxane group. These stabilizers are preferably used in quantities of from 0.5 to 2.5 wt. %, based on total weight of component A.

To influence the lambda ageing behavior and to improve the flame behavior and other mechanical properties of the PIR rigid foam, solid additives such as nanoparticles, lime, minerals, pigments or graphite, may be added to the polyol component. Examples of other solid additives which may optionally be incorporated in the polyol component of the invention are known from the literature. The quantities in which these solid additives are used range from 0 to 30 wt. %, based on total weight of component A.

It is also possible to incorporate hardeners such as polyols having OH numbers of 800 to 2000 and functionalities of 2 to 3 into component A. Examples of suitable hardeners are monoethylene glycol, monopropylene glycol and glycerol. The hardener is preferably used in a quantity of from 0 to 5 wt. %, based on total weight of component A.

The PIR rigid foams of the present invention are preferably produced in a one-step process and further preferably produced by the pouring process. Such one-step processes are known to those skilled in the art. In a one-step process, the reaction components are reacted together continuously or batchwise and then cured in or on suitable molds/substrates. Such processes are described in U.S. Pat. No. 2,764,565, in G. Oertel (ed.) “Kunststoff-Handbuch”, vol. VII, Carl Hanser Verlag, 3^{rd} edition, Munich 1993, p. 267 ff., and in K. Uhlig (ed.) “Polyurethan Taschenbuch”, Carl Hanser Verlag, 2^{nd} edition, Vienna 2001, p. 83-102.

The PIR rigid foams of the present invention have many uses as insulating materials. Examples of such uses from the construction industry are wall insulations, pipe sections or pipe half sections, roof insulations, wall panels and floor boards. In particular, they can be used for the insulation of containers and tanks, in particular beer tanks.

The present invention also provides the containers/container walls, in particular beer tanks, insulated with the PIR rigid foams of the present invention. These containers have walls made of a core of PIR rigid foam according to the invention and backing layers permanently attached thereto. The backing layers may be flexible or rigid. Examples of backing layers are paper backing layers, nonwoven backing layers, metal backing layers (e.g. steel, aluminum), wood and composite backing layers. The production of container walls of this type is known to those skilled in the art.

The reaction mixture of isocyanate component, polyol component and other additives and auxiliary substances, catalysts and blowing agents for the production of the PIR rigid foams can be cast in situ on or between the walls of a tank or container, in particular a beer tank.

A particular advantage of the container walls produced with the rigid foams according to the invention is the improved adhesion of the backing layers, good flow characteristics and excellent flame behavior.

The invention will be explained in more detail with the aid of the following examples.

### EXAMPLES

The following polyols were used in the amounts indicated in Table 1 to produce PIR rigid foams:

POLYOL 1: A polyether polyol having a hydroxyl number of 530 mg KOH/g, a functionality of 3 and a viscosity of 11000 mPas at 25° C., based on propylene oxide with bisphenol amine and bisphenol A as initiators (commercially available under the name Fox-O-Pol® M530 from Resina Chemie B V).
POLYOL 2: A polyester polyol having a hydroxyl number of about 240 mg KOH/g, a viscosity of about 2000 mPas at 25° C. and a functionality of 2, based on recycled polyethylene terephthalate (commercially available under the name Hoopol® F-1396 from Synthesia Espanola).
POLYOL 3: A polyether polyol having a hydroxyl number of 475 mg KOH/g, a viscosity of 19000 mPas at 25° C. and a functionality of 5.5, based on propylene oxide with sorbitol and 1,2-propylene glycol as initiators (commercially available under the name Fox-O-Pol® 475s from Resina Chemie B V).

PIR rigid foams were produced in the laboratory using a polyol component which included POLYOL 1, POLYOL 2 AND POLYOL 3 in the amounts indicated in Table 1. The flame retardant, foam stabilizers, catalysts, water and blowing agents identified in Table 1 were added to the polyol component in the amounts indicated in Table 1 and the mixture thus obtained was mixed with the polyisocyanate (a mixture of MDI isomers and their higher homologues having an NCO content of 31 wt. %, commercially available under the name Desmodur® 44V40L from Bayer MaterialScience AG) in the amount indicated in Table 1. The mixing took place using a mixing unit in the medium pressure range at component temperatures of 35° C. The mixture was then poured into a mold. The foam formulations and their physical properties are reported in Table 1.

The reported density was calculated on a 10×10×10 cm³ cube by determining the weight. The lambda values were determined by means of the heat flow method in accordance with DIN 52616 at a central temperature of 10° C. (Fox device). The fire properties were determined in accordance with DIN 4102. The adhesion was determined in accordance with DIN 53292.

TABLE 1

| | Ex. 1 | Ex. 2 | Ex. 3 | Ex. 4 |
|---|---|---|---|---|
| POLYOL 1 [pbw] | 10 | 20 | 30 | 0 |
| POLYOL 2 [pbw] | 30 | 20 | 10 | 40 |
| POLYOL 3 [pbw] | 60 | 60 | 60 | 60 |
| TCPP [pbw], flame retardant | 50 | 50 | 50 | 50 |
| Dabco BL11 [pbw], catalyst | 0.15 | 0.15 | 0.15 | 0.15 |
| Kosmos 33 [pbw], PIR catalyst | 1 | 1 | 1 | 1 |
| Cardura E10P [pbw], stabilizer | 1 | 1 | 1 | 1 |
| Dabco DC193 [pbw], foam stabilizer | 1 | 1 | 1 | 1 |
| Struksilon 8015 [pbw], foam stabilizer | 1.7 | 1.7 | 1.7 | 1.7 |
| Water [pbw] | 0.65 | 0.65 | 0.65 | 0.65 |
| Blowing agent 365/245 [pbw] | 22.2 | 22.2 | 22.2 | 22.2 |
| Total [pbw] | 177.7 | 177.7 | 177.7 | 177.7 |
| Viscosity [mPa · s] at 25° C. | 280 | 260 | 240 | 300 |
| Density [kg/m³] at 25° C. | 1210 | 1211 | 1212 | 1185 |
| Isocyanate [pbw] | 180.5 | 180.4 | 180.3 | 184.5 |
| Index | 193 | 193 | 193 | 195 |
| Cream time [sec] | 10 | 9 | 9 | 11 |
| Gel time [sec] | 50 | 47 | 40 | 52 |
| Foam density [kg/m³], EN 1602 | 50.4 | 50 | 50 | 50 |
| Compressive strength [kPa], 10% | 302 | 310 | 315 | 290 |
| compression, EN 826 | | | | |
| Modulus of elasticity [N/mm²] acc. to EN 826 | 17.1 | 17.1 | 17.1 | 17.1 |
| Dim. stability [%], 24 h, −25° C., EN 1604: | | | | |
| Length | −0.1 | −0.1 | −0.1 | −0.1 |
| Width | −0.1 | −0.1 | −0.1 | −0.1 |
| Thickness | 0.0 | 0.0 | 0.0 | 0.0 |
| Adhesive strength [kPa], DIN 53292 | 160 | 150 | 140 | 170 |
| Lambda at 10° C. [W/mK] acc. to DIN 52612 | 0.0218 | 0.0220 | 0.0221 | 0.0217 |
| Flame behaviour [mm], DIN 4102 Part 1 | 90 | 87 | 85 | 102 |

pbw = parts by weight
TCPP: Tris(β-chloroisopropyl) phosphate
Dabco BL11: Bis(2-dimethylaminoethyl) ether, 70% in dipropylene glycol
Cardura E10P: C₁₃H₂₄O₃, glycidyl ester of saturated monocarboxylic acid mixture of highly branched C₁₀ isomers
Dabco DC 193 silicone oil from Air Products
Struksilon 801: polyether-modified dimethylpolysiloxane
Blowing agent 365/245: 60:40 mixture of HFC 365 mfc and HFC 245 fa
Kosmos 33: 30% solution of potassium acetate in diethylene glycol from
Goldschmidt GmbH

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A PIR rigid foam comprising the reaction product of
a) an organic polyisocyanate component and
b) a polyol component comprising
(i) at least one polyester polyol, and
(ii) at least one polyether polyol and, optionally,
(c) one or more auxiliary substances and additives, blowing agents, water, and catalysts
in amounts such that a ratio of volume of the polyol component to the organic polyisocyanate component equal to from 100:100 to 100:110 and an index of from 100 to 400 are achieved.

2. The PIR rigid foam of claim 1 in which the index is from 185 to 250.

3. The PIR rigid foam of claim 1 in which the organic polyisocyanate component comprises a mixture of MDI isomers and their higher homologues having an NCO content of 28 to 32 wt. %.

4. The PIR rigid foam of claim 3 in which the polyol component comprises a mixture of (i) a polyester polyol having an OH number of 220 to 260 mg KOH/g, a viscosity of 1500 to 2500 mPas at 25° C. and a functionality of from 2 to 2.5 based on polyethylene terephthalate and (ii) a polyether polyol having an OH number of 450 to 500 mg KOH/g and a functionality of 5 to 6 based on propylene oxide with sorbitol and 1,2-propylene glycol as initiators, water, a blowing agent and a catalyst.

5. The PIR rigid foam of claim 1 in which the polyol component comprises a mixture of (i) a polyester polyol having an OH number of 220 to 260 mg KOH/g, a viscosity of 1500 to 2500 mPas at 25° C. and a functionality of from 2 to 2.5 based on polyethylene terephthalate and (ii) a polyether polyol having an OH number of 450 to 500 mg KOH/g and a functionality of 5 to 6 based on propylene oxide with sorbitol and 1,2-propylene glycol as initiators, water, a blowing agent and a catalyst.

6. A process for the production of a PIR rigid foam comprising reacting
a) an organic polyisocyanate component and
b) a polyol component comprising
(i) at least one polyester polyol, and
(ii) at least one polyether polyol and
(c) one or more auxiliary substances and additives, blowing agents, water, and catalysts
in amounts such that a ratio of volume of the polyol component to the organic polyisocyanate component equal to from 100:100 to 100:110 and an index of from 100 to 400 are achieved.

7. An insulated container comprising the PIR rigid foam of claim 1.

8. An insulated tank comprising a tank having at least one wall insulated with the PIR rigid foam of claim 1.

9. A beer tank insulated with the PIR rigid foam of claim 1.
